(19) United States
(12) Patent Application Publication
(10) Pub. No.: US 2004/0061313 A1
(43) Pub. Date: Apr. 1, 2004

(54) Extendible trailer

(76) Inventor: John R. Courtney, Regis Falls, NY (US)

Correspondence Address: HANCOCK & ESTABROOK, LLP, 1500 MONY Tower I, PO Box 4976, Syracuse, NY, 13221-4976, US

(21) Appl. No.: 10/261,838

(22) Filed: Sep. 30, 2002

(51) Int. Cl. B62B 1/00

(52) U.S. Cl. 280/656

(57) ABSTRACT

The present invention provides an extendible trailer generally consisting of three trailer sections arranged in side-by-side relation. The two outside trailer sections are connected to the central trailer section and are movable relative thereto along an axis that extends transverse to the longitudinal axis of the trailer. Two pairs of lead screws respectively interconnect the two outer trailer sections to the central trailer section, and a drive chain and cogged drive wheel assembly interconnects the two lead screws connected to each trailer section. By rotating any one the lead screws, the drive chain and cogged drive wheel assembly effectively moves the corresponding outer trailer section either toward or away from the central trailer section, thereby decreasing or increasing, respectively, the effective width of the trailer.

### BACKGROUND OF THE INVENTION

1. Field of Invention

The present invention relates generally to trailers designed to be towed behind a vehicle, and more particularly to such trailers that have adjustable widths.

2. Description of Prior Art

Trailers are commonly used by outdoorsman and others to carry cargo behind a vehicle. The cargo may consist of, for example, all terrain vehicles (ATVs), farm equipment and machinery, camping equipment, bicycles, furniture, and like articles that are generally too large to fit in the cargo space of a traditional vehicle. The trailers generally consist of a rigid frame that supports a bed on which cargo may be placed. Depending on the intended use of the trailer, the width and length may vary. However, wider trailers are not as maneuverable as the smaller width trailers due to space constraints, but the smaller width trailers lack the cargo space to carry a large amount of cargo.

Foldable and extendible trailers have been developed to remedy the drawback of having a single width/length trailer. Examples of such trailers can be readily seen in U.S. Pat. No. 4,746,142 to Davis; U.S. Pat. No. 3,913,934 to Koehn et al.; U.S. Pat. No. 4,397,476 to Bolyard et al.; U.S. Pat. No. 4,786,073 to Harper; U.S. Pat. No. 4,822,069 to Burgess; U.S. Pat. No. 4,995,129 to Comardo; U.S. Pat. No. 5,354,090 to Grovom; U.S. Pat. Nos. 5,340,145 and 5,607,176 both to Leib et al; U.S. Pat. No. 6,102,468 to Lowrey et al.; U.S. Pat. No. 6,254,117 to Cross; and U.S. Pat. No. 6,378,893 to Jager.

3. Objects and Advantages

It is a principal object and advantage of the present invention to provide a new and improved extendible trailer that is adjustable between minimum and maximum widths.

It is a further object and advantage of the present invention to provide an extendible trailer that may be pulled behind a traditional road vehicle, such as a pick up truck, or an off road vehicle, such as an ATV.

Other objects and advantages of the present invention will in part be obvious, and in part appear hereinafter.

### SUMMARY OF THE INVENTION

In accordance with the foregoing objects and advantages, the present invention provides an extendible trailer comprising three trailer sections arranged in side-by-side relation. The two outside trailer sections are connected to the central trailer section and are movable relative thereto along an axis that extends transverse to the longitudinal axis of the trailer. Two pairs of lead screws respectively interconnect the two outer trailer sections to the central trailer section, and a drive chain and cogged drive wheel assembly interconnects the two lead screws connected to each trailer section. By rotating any one the lead screws, the drive chain and cogged drive wheel assembly effectively moves the corresponding outer trailer section either toward or away from the central trailer section, thereby decreasing or increasing, respectively, the effective width of the trailer.

In use, the trailer is designed to be pulled behind a vehicle and with its sections positioned in their maximum width setting, carry at least two ATVs and other equipment (such as camping equipment) thereon. Once reaching a desired destination where road vehicles can no longer travel (i.e., the woods), the ATVs can be unloaded from the trailer, the trailer sections can be adjusted to their minimum width setting, and can then be pulled behind one of the ATVs carrying the other equipment thereon.

### BRIEF DESCRIPTION OF THE DRAWINGS

The present invention will be more fully described and understood by reading the following Detailed Description in conjunction with the accompanying drawings, in which:

FIG. 1 is a top plan view of the present invention;

FIG. 2 is a front elevation thereof;

FIG. 3 is a side elevation view thereof;

FIG. 4 is an enlarged view of the circled portion labeled 4 in FIG. 2; and

FIG. 5 is an enlarged view of the encircled portion labeled 5 in FIG. 3.

### DETAILED DESCRIPTION

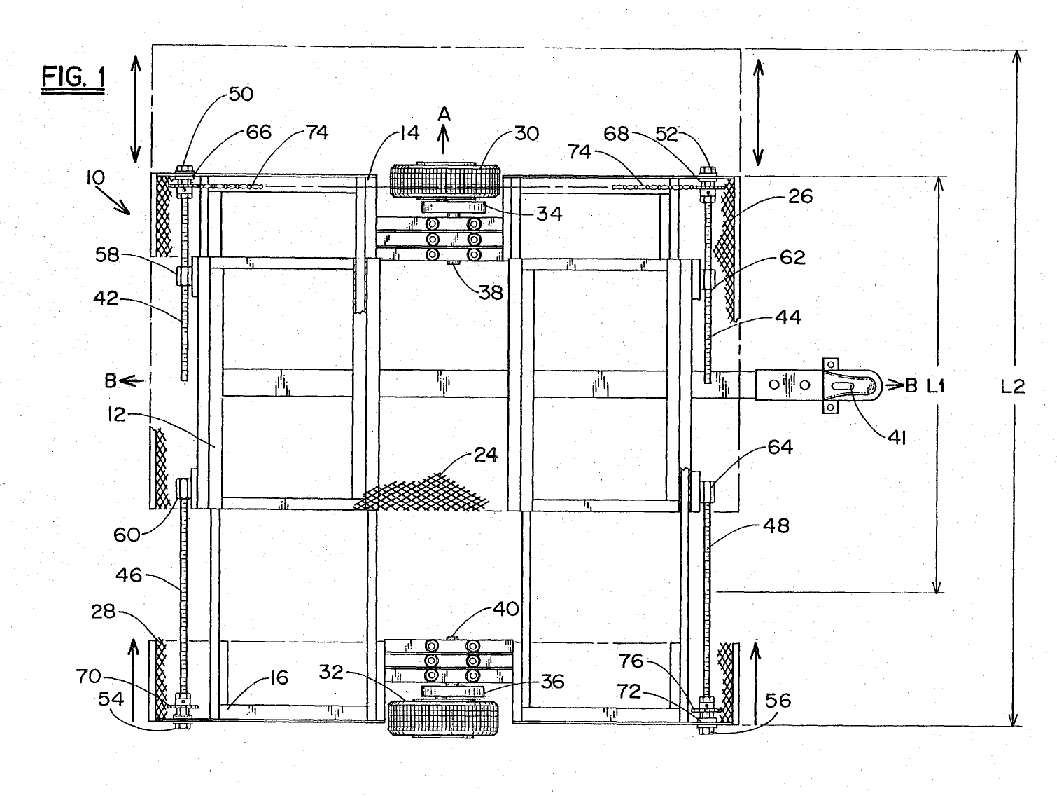

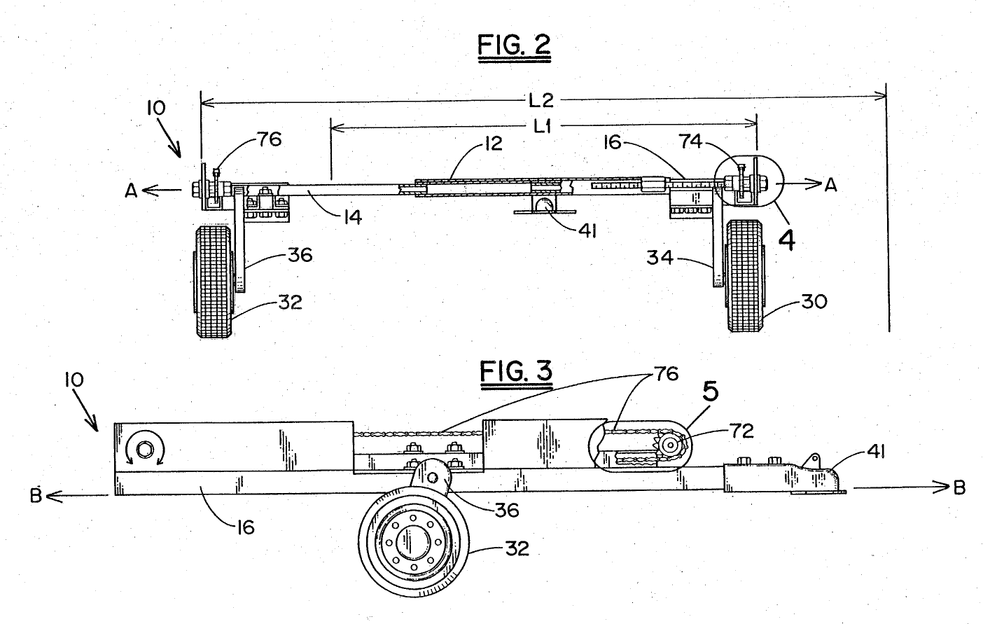

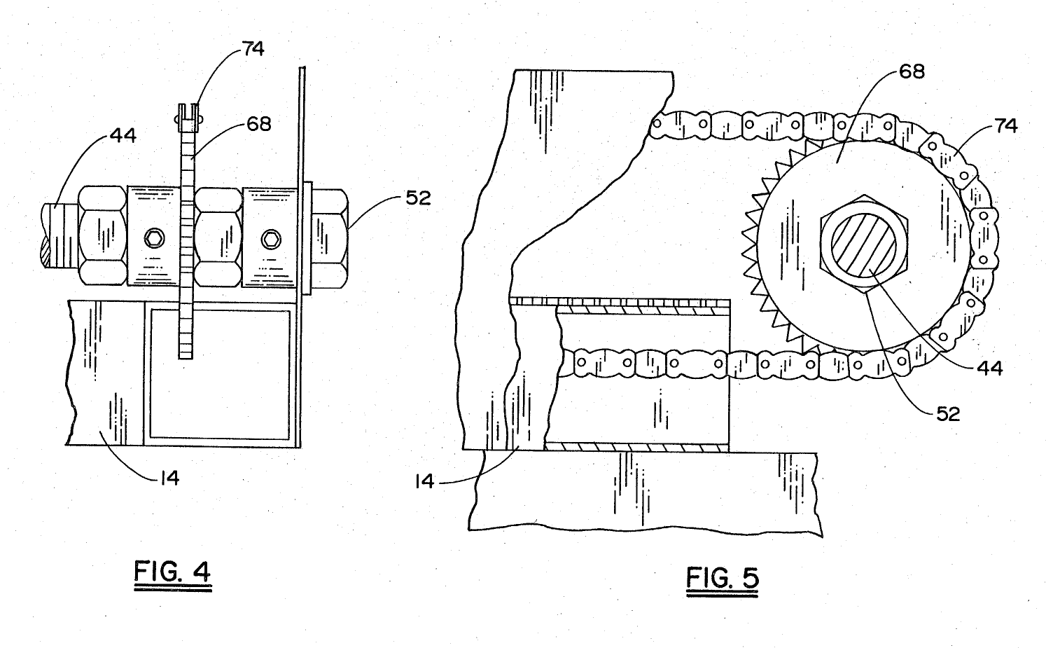

Referring now to the drawings in which like reference numerals refer to like parts throughout, there is seen in FIG. 1 an extendible trailer, designated generally by reference numeral 10, and comprising first (center), second (left), and third (right) trailer sections 12, 14, and 16, respectively. As will be described in greater detail hereinafter, second and third trailer sections 14, 16 are both connected to first trailer section 12 for movement relative thereto along a common axis A-A that extends transverse to the longitudinal axis B-B of first trailer section 12. Movement of trailer sections 14, 16 between their terminal positions permits trailer 10 to have a minimum width L1 (preferably about 40 inches wide) and a maximum width L2 (preferably about 100 inches wide), as illustrated in FIGS. 1 and 2, or any intermediate width between those two dimensions.

Trailer sections 12, 14, and 16 are of substantially equal lengths and each comprise frames 18, 20, and 22, respectively, preferably constructed of channel iron, tubular steel, or other suitably strong and rigid material common to trailer frame construction, and a bed 24, 26, and 28, respectively (partially illustrated in the drawings), attached in covering relation to the frames 18, 20, and 22. Beds 24, 26, and 28 are illustrated as being composed of a steel mesh material, such as a wire grating, but could be solid, such as wood planks or sheets, or other material common to trailer bed construction. When moved toward their minimum width positions, the necessary portions of frames 20 and 22 telescopically engage the corresponding portion of frame 18 in order to accommodate the trailer section movement.

Wheels 30, 32 are rotatably connected by wheel carriages 34, 36 and axles 38, 40 (i.e., in a conventional manner) to second and third trailer sections 14, 16, respectively, and a conventional hitch 41 is rigidly connected to first trailer section 12, thereby providing the mechanisms to pull and interconnect trailer 10 to a vehicle.

Two pairs of threaded lead screws 42, 44, and 46, 48 interconnect second and third trailer sections 14, 16 to first trailer section 12, respectively. Lead screws 42 and 46 are connected to the rear-most frame members on trailer sections 14, 16, respectively, while lead screws 44, 48 extend parallel to lead screws 42 and 46, respectively, and are connected to the front-most frame members of those trailer sections. In addition, due to the substantially equal lengths of the trailer sections, lead screws 42 and 46, and 44 and 48 extend along respective common axes. The heads of lead screws 42, 44, 46, and 48 are rigidly connected to a hex-head bolt 50, 52, 54, and 56, respectively, adapted to be engaged by a wrench or power tool adapter so as to rotate the lead screws. Two pairs of bolts 58, 60 and 62, 64 are rigidly connected to the rear and front frame members of first trailer section 12, respectively, and lead screws 42, 44, 46, and 48 threadingly pass therethrough, respectively.

Cogged drive wheels (i.e., sprockets) 66, 68, 70, and 72 are rigidly connected to lead screws 42, 44, 46, and 48, respectively, adjacent the head ends thereof. Linked drive chains 74 and 76 operatively engage and pass around drive wheels 66, 70 and 68, 72, respectively, thereby interconnecting lead screws 42, 44 and 46, 48, respectively. To move second trailer section 14 along axis A-A, either bolt 50 or 52 is engaged with a drill or other suitable tool, and rotated, thereby driving both lead screws 42 and 44 in the corresponding direction and causing the trailer section to move toward or away from first trailer section 12. Likewise, to move third trailer section 16 along axis A-A, either bolt 54 or 56 is engaged with a drill or other suitable tool, and rotated, thereby driving lead screws 46 and 48 in the corresponding direction and causing the trailer section to move toward or away from first trailer section 12. Of course, both pairs of lead screws are simultaneously moved through actuation of only one of the bolts due to the drive chains 74 and 76, and cogged drive wheels 66, 68, 70, and 72.

It is contemplated that other trailer drive mechanisms could be implemented with the present invention. For instance, instead of using lead screws, a pair of scissor linkages commonly used to raise and lower hoisting devices could be constructed.

Alternatively, hydraulic or pneumatic piston/cylinder arrangements could be substituted for the lead screw arrangement.

Functionally, trailer 10 is designed to be pulled behind a vehicle and with its sections positioned in their maximum width setting, carry at least two ATVs and other equipment (such as camping equipment). Once reaching a desired destination where road vehicles can no longer travel (i.e., the woods), the ATVs can be unloaded from trailer 10, trailer sections 12, 14 and 16 can be adjusted to be in their minimum width setting, and can then be pulled behind one of the ATVs while carrying the other equipment thereon.

What is claimed is:

1. An extendible trailer, comprising:
a. a first trailer section extending along a first longitudinal axis;
b. a second trailer section interconnected to said first trailer section for movement relative thereto along a second axis that is transverse to said first axis;
c. a third trailer section interconnected to said first trailer section for movement relative thereto along said second axis;
d. means for moving said second trailer section relative to said first trailer section; and
e. means for moving said third trailer section relative to said first trailer section.

2. The extendible trailer according to claim 1, wherein said means for moving said second trailer section relative to said first trailer section comprises first and second lead screws each interconnected between said first and second trailer sections, and interconnected to one another by a chain.

3. The extendible trailer according to claim 1, wherein said means for moving said third trailer section relative to said first trailer section comprises third and fourth lead screws each interconnected between said first and third trailer sections, and interconnected to one another by a chain.

4. The extendible trailer according to claim 1, wherein said first, second, and third trailer sections each comprise a respective frame and a respective bed extending in covering relation to each of said frames.

5. The extendible trailer according to claim 4, wherein said bed is composed of steel mesh.

6. The extendible trailer according to claim 1, wherein said first, second, and third trailer sections include first, second, and third frames, respectively.

7. The extendible trailer according to claim 6, wherein respective portions of said first frame are adapted to telescopically engage corresponding portions of said second frame and said third frame, whereby said second and third trailer sections may be nestingly positioned relative to said first trailer section.

8. An extendible trailer, comprising:
a. a first trailer section extending along a first longitudinal axis;
b. a second trailer section interconnected to said first trailer section for movement relative thereto along a second axis that is transverse to said first axis;
c. a third trailer section interconnected to said first trailer section for movement relative thereto along said second axis;
d. a first lead screw interconnecting said first trailer section to said second trailer section; and
e. a second lead screw interconnecting said first trailer section to said third trailer section.

9. The extendible trailer according to claim 8, further comprising a third lead screw interconnecting said first trailer section and said second trailer section, and extending parallel to said first lead screw.

10. The extendible trailer according to claim 9, further comprising first and second cogged drive wheels connected to said first and third lead screws, respectively, and a first drive chain interconnecting said first and third lead screws and extending in engaging relation to said first and second cogged drive wheels.

11. The extendible trailer according to claim 8, further comprising a fourth lead screw interconnecting said first trailer section and said third trailer section, and extending parallel to said second lead screw.

12. The extendible trailer according to claim 11, further comprising third and fourth cogged drive wheels connected to said second and fourth lead screws, respectively, and a second drive chain interconnecting said second and fourth lead screws and extending in engaging relation to said third and fourth cogged drive wheels.

13. The extendible trailer according to claim 8, wherein said first, second, and third trailer sections each comprise first, second, and third frames, respectively, and first second, and third beds positioned in covering relation to said first, second, and third frames, respectively.

14. The extendible trailer according to claim 13, wherein said first, second, and third beds are composed of steel mesh.
